(19) United States
(12) Patent Application Publication
(10) Pub. No.: US 2025/0069002 A1
(43) Pub. Date: Feb. 27, 2025

(54) Machine Learning-Based Requirements Prediction

(71) Applicant: Bank of America Corporation, Charlotte, NC (US)

(72) Inventors: Manu Kurian, Dallas, TX (US); Michael Horstman, Chicago, IL (US); Radha Karuppannan, Huntersville, NC (US)

(21) Appl. No.: 18/235,947

(22) Filed: Aug. 21, 2023

(51) Int. Cl. G06Q 10/0631; G06Q 10/087; G06Q 30/0202

(52) U.S. Cl. CPC G06Q 10/06315; G06Q 10/087; G06Q 30/0202

(57) ABSTRACT

Arrangements for machine learning-based requirements predictions are provided. In some examples, user data may be received from a plurality of sources. In some arrangements, the user data may be segmented according to item type and anonymized to protect private information. The segmented, anonymized data may be analyzed using machine learning to output one or more requirements predictions. In some examples, an entity may request access to requirements prediction data. The request and/or entity may be validated and, if validated, access to the requirements prediction data may be provided. In some arrangements, additional analysis may be performed on the data to identify secondary entities associated with additional materials related to a particular item type. A prediction associated with volumes or amounts of additional materials may be generated and, in some examples, transmitted to the identified secondary entities.

### BACKGROUND

Aspects of the disclosure relate to electrical computers, systems, and devices providing machine learning-based requirements or needs predictions.

As manufacturing and supply availability fluctuate, consumers may find that it is difficult to reliably obtain goods or services upon which they have come to rely. In addition, enterprise organizations may have difficulty understanding and projecting needs (e.g., cash needs, materials needs, manufacturing needs, or the like). Accordingly, it would be advantageous to use machine learning to analyze user data to accurately predict needs for various entities.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with accurately predicting needs in various industries and areas.

In some examples, user data may be received. The user data may be received from a plurality of sources. In some arrangements, the user data may be segmented according to item type and anonymized to protect private information. The segmented, anonymized data may be analyzed using machine learning to output one or more requirements predictions.

In some examples, an entity may request access to requirements prediction data. The request and/or entity may be validated and, if validated, access to the requirements prediction data may be provided.

In some arrangements, additional analysis may be performed on the data to identify secondary entities associated with additional materials related to a particular item type. A prediction associated with volumes or amounts of additional materials may be generated and, in some examples, transmitted to the identified secondary entities.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing machine learning-based requirements predictions in accordance with one or more aspects described herein;

FIGS. 2A-2F depict an illustrative event sequence for implementing machine learning-based requirements prediction in accordance with one or more aspects described herein;

FIG. 3 depicts an illustrative method for implementing machine learning-based requirements prediction in accordance with one or more aspects described herein;

FIG. 4 illustrates an example graphical user interface that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, accurately understanding things like manufacturing needs, cash position of an enterprise organization, and the like, can be difficult and unpredictable. Accordingly, aspects described herein use machine-learning to analyze consumer data and generate predictions for manufacturing items, raw materials associated with manufacture of items, real-time or future cash position of an entity, or the like.

In some examples, consumer data such as purchase data may be received from a plurality of entities, users or sources. The data may be segmented to identify data associated with particular item types (e.g., if multiple items are purchase in one data entry the data may be segmented to split the purchase by item type). In some examples, the data may also be anonymized to protect private or confidential information.

In some arrangements, a machine learning model may be used to analyze the segmented, anonymized data. The data may be input the model and the model may output a requirements prediction or needs prediction. In some examples, the requirements prediction may include a number or volume of units of a particular item type that should be manufactured to satisfy a predicted need over a period of time.

In some examples, additional analysis may be performed to identify suppliers of manufacturers and amounts of raw materials needed to manufacture the number or volume of units of the particular item type for the period of time. The prediction data may be shared with registered and/or validated entities.

These and various other arrangements will be discussed more fully below.

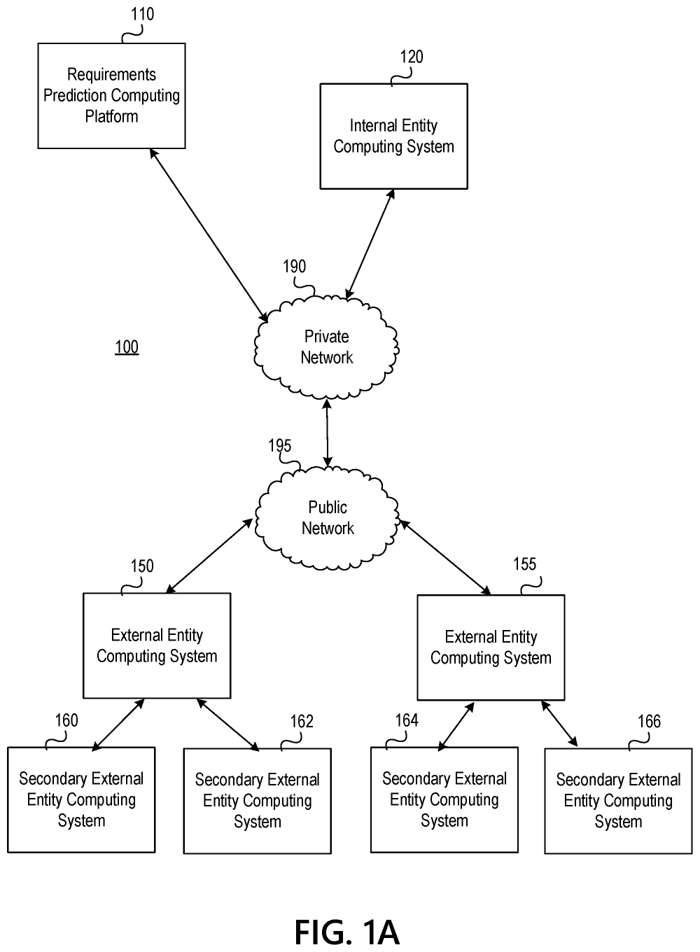

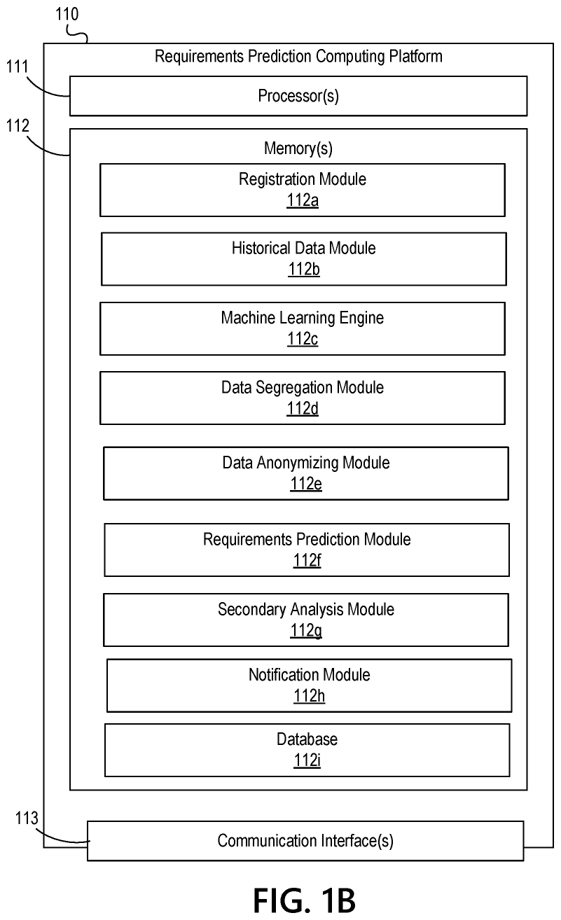

FIGS. 1A-1B depict an illustrative computing environment for implementing machine learning-based requirements prediction in accordance with one or more aspects described herein. Referring to FIG. 1A, computing environment 100 may include one or more computing devices and/or other computing systems. For example, computing environment 100 may include requirements prediction computing platform 110, internal entity computing system 120, external entity computing system 150, external entity computing system 155, secondary external entity computing system 160, secondary external entity computing system 162, secondary external entity computing system 164, and secondary external entity computing system 166. Although one internal entity computing system 120, two external entity computing systems 150, 155, and two secondary external entity computing systems 160/162, 164/166 associated with each external entity computing system are shown, any number of devices or systems may be used without departing from the invention.

Requirements prediction computing platform 110 may be or include one or more computing devices (e.g., servers, server blades, or the like) and/or one or more computing components (e.g., memory, processor, and the like) and may be configured to provide dynamic, efficient machine learning-based requirements prediction. For instance, requirements prediction computing platform 110 may receive data related to one or more purchases (e.g., of services, goods, or the like). In some examples, the data may be received based on transaction data.

Additionally or alternatively, receipt or invoice data may be uploaded to the requirements prediction computing platform 110.

The requirements prediction computing platform 110 may segment the purchase data by item type (e.g., if more than one item is associated with a transaction or receipt, the items may be associated with an item type and the data segmented based on item type). Further, the requirements prediction computing platform 110 may anonymize the data by stripping or masking any user identifying data associated with the purchase. The requirements prediction computing platform 110 may analyze the segmented, anonymized data using a machine learning model trained using historical purchase data. The machine learning model may output a predicted need associated with an item type.

One or more external entities (e.g., via external entity computing system 150 and/or external entity computing system 155) may request to retrieve the predicted need output by the machine learning model. The request may be validated by the requirements prediction computing platform 110 and, if the entity if authorized, the entity system may access the predicted need output related to an item type the entity is authorized to access.

In some examples, the requirements prediction computing platform 110 may further analyze the predicted need (e.g., via secondary analysis) to identify one or more secondary external entities that may be related to the item type and may send or transmit the predicted need to the one or more secondary external entities. In some examples, if an external entity computing system 150 is associated with a vendor or supplier or an item, the secondary external entities associated therewith (e.g., secondary external entity computing system 160, secondary external entity computing system 162) may be suppliers to the external entity of raw materials associated with the item type.

Although only primary and secondary external entity levels are shown, aspects described herein may be used to identify and inform additional levels of external entities (e.g., suppliers of materials to the secondary externa entities, or the like).

Internal entity computing system 120 may be or include one or more computing devices (e.g., servers, server blades, or the like) and/or one or more computing components (e.g., memory, processor, and the like) and may be configured to host or execute one or more applications configured to receive, process and the like, transactions, purchases, or the like, for an enterprise organization. Internal entity computing system 120 may receive purchase and/or receipt data from users (e.g., individual users, corporate users, vendors, or the like) and may store the data, process transactions, modify account ledgers, and the like. Internal entity computing system 120 may further store historical transaction or purchase data.

External entity computing system 150 and/or external entity computing system 155 may be or include or more computing devices (e.g., servers, server blades, or the like) and/or one or more computing components (e.g., memory, processor, and the like) and may be associated with one or more entities external to the enterprise organization. External entity computing system 150 and/or external entity computing system 155 may be associated with one or more vendors, service providers, suppliers, retail entities, or the like. In some examples, external entity computing system 150 and/or external entity computing system 155 may store historical data related to previous purchases, services provided, and the like. External entity computing system 150 and/or external entity computing system 155 may be configured to access, with appropriate authentication or validation, requirements prediction computing platform 110 to access predicted requirements.

Secondary external entity computing system 160, secondary external entity computing system 162, secondary external entity computing system 164 and/or secondary external entity computing system 166 may be or include or more computing devices (e.g., servers, server blades, or the like) and/or one or more computing components (e.g., memory, processor, and the like) and may be associated with one or more external entities. In some examples, the secondary external entity computing systems 160-166 may be associated with suppliers of the primary external entities associated with external entity computing system 150 and/or external entity computing system 155. For instance, secondary external entity computing systems 160 and 162 may supply raw materials to the external entity associated with external entity computing system 150, while secondary external entity computing systems 164 and 166 may supply raw materials to the external entity associated with external entity computing system 155.

As mentioned above, computing environment 100 also may include one or more networks, which may interconnect one or more of requirements prediction computing platform 110, internal entity computing system 120, external entity computing system 150, external entity computing system 155, secondary external entity computing system 160, secondary external entity computing system 162, secondary external entity computing system 164, and/or secondary external entity computing system 166. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, requirements prediction computing platform 110 and internal entity computing system 120 may be associated with an enterprise organization (e.g., a financial institution), and private network 190 may be associated with and/or operated by the organization, and may include one or more networks (e.g., LANs, WANs, virtual private networks (VPNs), or the like) that interconnect requirements prediction computing platform 110 and internal entity computing system 120 and one or more other computing devices and/or computer systems that are used by, operated by, and/or otherwise associated with the organization. Public network 195 may connect private network 190 and/or one or more computing devices connected thereto (e.g., requirements prediction computing platform 110, internal entity computing system 120) with one or more networks and/or computing devices that are not associated with the organization. For example, external entity computing system 150, external entity computing system 155, secondary external entity computing system 160, secondary external entity computing system 162, secondary external entity computing system 164, and/or secondary external entity computing system 166 might not be associated with an organization that operates private network 190 (e.g., because external entity computing system 150, external entity computing system 155, secondary external entity computing system 160, secondary external entity computing system 162, secondary external entity computing system 164, and/or secondary external entity computing system 166 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 150, external entity computing system 155, secondary external entity computing system 160, secondary external entity computing system 162, secondary external entity computing system 164, and/or secondary external entity computing system 166 to private network 190 and/or one or more computing devices connected thereto (e.g., requirements prediction computing platform 110, internal entity computing system 120).

Referring to FIG. 1B, requirements prediction computing platform 110 may include one or more processors 111, memory 112, and communication interface 113. A data bus may interconnect processor(s) 111, memory 112, and communication interface 113. Communication interface 113 may be a network interface configured to support communication between requirements prediction computing platform 110 and one or more networks (e.g., network 190, network 195, or the like). Memory 112 may include one or more program modules having instructions that when executed by processor(s) 111 cause requirements prediction computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of requirements prediction computing platform 110 and/or by different computing devices that may form and/or otherwise make up requirements prediction computing platform 110.

For example, memory 112 may have, store and/or include registration module 112a. Registration module 112a may store instructions and/or data that may cause or enable the requirements prediction computing platform 110 to receive registration data associated with one or more entities, customers, vendors, or the like, requesting to access requirements predictions generated by the requirements prediction computing platform 110. In some examples, the registration data may include identification of the entity, identification of one or more systems or devices associated with the entity, authentication data of the entity (e.g., key of a public/private key pair, login credentials, or the like), and the like. In some examples, the registration data may include identification of one or more item types to which the entity is requesting access.

Requirements prediction computing platform 110 may further have, store and/or include historical data module 112b. Historical data module 112b may store instructions and/or data that may cause or enable the requirements prediction computing platform 110 to retrieve historical purchase or transaction data, receive uploaded receipt data, receive transaction data, and the like. In some examples, historical data module 112b may store data that may be used to train a machine learning model.

For instance, requirements prediction computing platform 110 may further have, store and/or include machine learning engine 112c. Machine learning engine 112c may store instructions and/or data that may cause or enable the requirements prediction computing platform 110 to train, execute, validate and/or update one or more machine learning models that may be used to evaluate purchase or transaction data to identify, predict or otherwise output requirements predictions. For instance, the machine learning model may receive, as inputs, segmented, anonymized data associated with a particular item type and may generate a predicted need for the item for a period of time (e.g., one month, six months, one year, or the like). By segmenting the data, the computing resources needed to generate the prediction may be reduced because an amount data being analyzed by the machine learning engine to output one prediction is reduced. Further, by anonymizing the data, personal user information may be protected and predictions by, for instance, geographic area, may be generated.

In some examples, the machine learning model may be trained using historical transaction and/or purchase data. For instance, the machine learning model may be trained using data associated with purchases of particular items, time of year of purchase, day of week of purchase, external events (e.g., market changes, natural disaster, or the like) to identify correlations between the purchases and associated data, and potential needs or requirements of vendors that supply items that were purchased. Accordingly, the machine learning model may learn to recognize patterns within data that may be used to output requirement predictions for numbers of items to produce, raw materials needed to product the items, and the like, for a particular time period.

The machine learning model may use, as inputs, current purchase data, receipt data, or the like, as well as additional information such as external events, time of year, or the like. The model may be executed to output a predicted need for items of one or more item types, raw materials to generate the items, and the like.

In some examples, a dynamic feedback loop may be used to continuously update or validate the machine learning model. For instance, inventory data, sales data, and the like, of registered entities may be used to update or validate the model to improve accuracy of requirements predictions.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data and/or unlabeled data.

Requirements prediction computing platform 110 may further have, store and/or include data segmentation module 112d. Data segmentation module 112d may store instructions and/or data that may cause or enable the requirements prediction computing platform 110 to segment current purchase data, receipt uploads, or the like, to identify items of different item types within the data. In some examples, segmenting the data may include segmenting data from a purchase and then aggregating the segmented item type data with segmented data of the same item type from other purchases.

Requirements prediction computing platform 110 may further have, store and/or include data anonymizing module 112e. Data anonymizing module 112e may store instructions and/or data that may cause or enable the requirements prediction computing platform 110 to remove personal or user identifying data from purchase data, receipt uploads, and the like. In some examples, personal data may be stripped or masked from the purchase data prior to analyzing the data to generate a requirements prediction.

Requirements prediction computing platform 110 may further have, store and/or include requirements prediction module 112f. Requirements prediction module 112f may receive an output of the machine learning model and generate requirements prediction information that may be accessed by one or more registered entities. As discussed, in some examples, entities may be limited to accessing only data associated with particular item types (e.g., products or services provided by the entity). Requirements prediction module 112f may, in some examples, validate requests from entities to access requirements prediction data.

Requirements prediction computing platform 110 may further have, store and/or include secondary analysis module 112g. Secondary analysis module 112g may store instructions and/or data that may cause or enable the requirements prediction computing platform 110 to further analyze requirements predictions (e.g., output by the machine learning model) to identify secondary entities that may provide materials to primary entities to generate the items predicted. For instance, raw materials needed to generated the predicted items may be identified and suppliers of those materials may be identified.

Requirements prediction computing platform 110 may further have, store and/or include notification module 112h. Notification module 112h may store instructions and/or data that may cause or enable the requirements prediction computing platform 110 to generate one or more notifications. For instance, notifications to primary external entities indicating that requirements predictions have been generated, notifications to secondary external entities indicating potential needs related to the requirements predictions, and the like, may be generated.

Requirements prediction computing platform 110 may further have, store and/or include a database 112i. Database 112i may store data associated with historical transactions, registration data, requirements predictions and/or other data that enables performance of the aspects described herein by the requirements prediction computing platform 110.

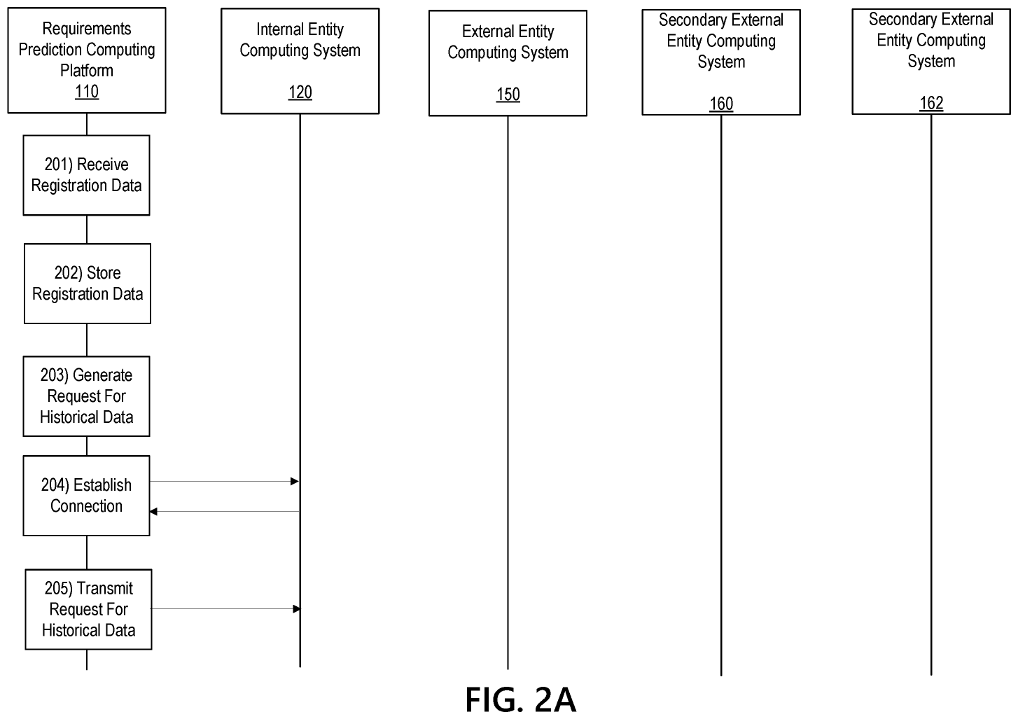

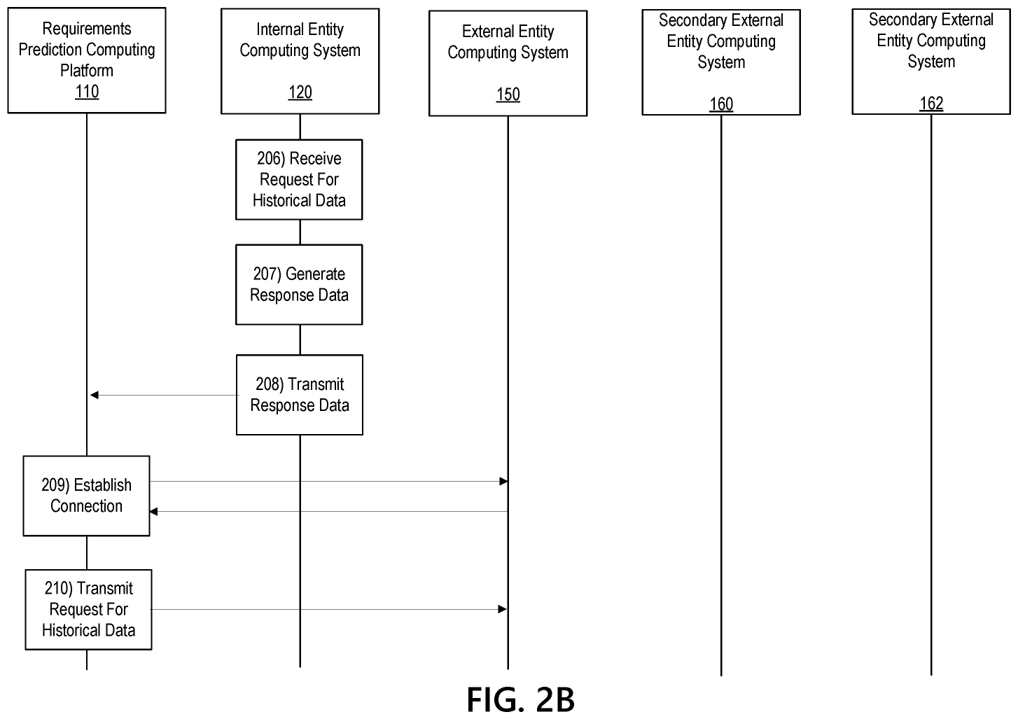

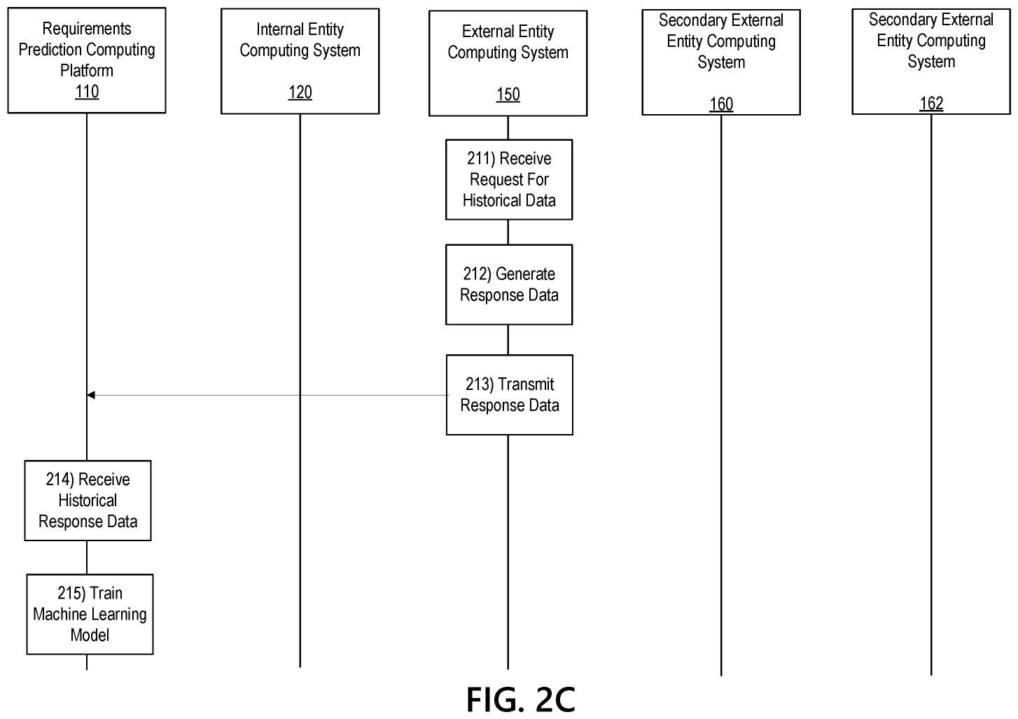

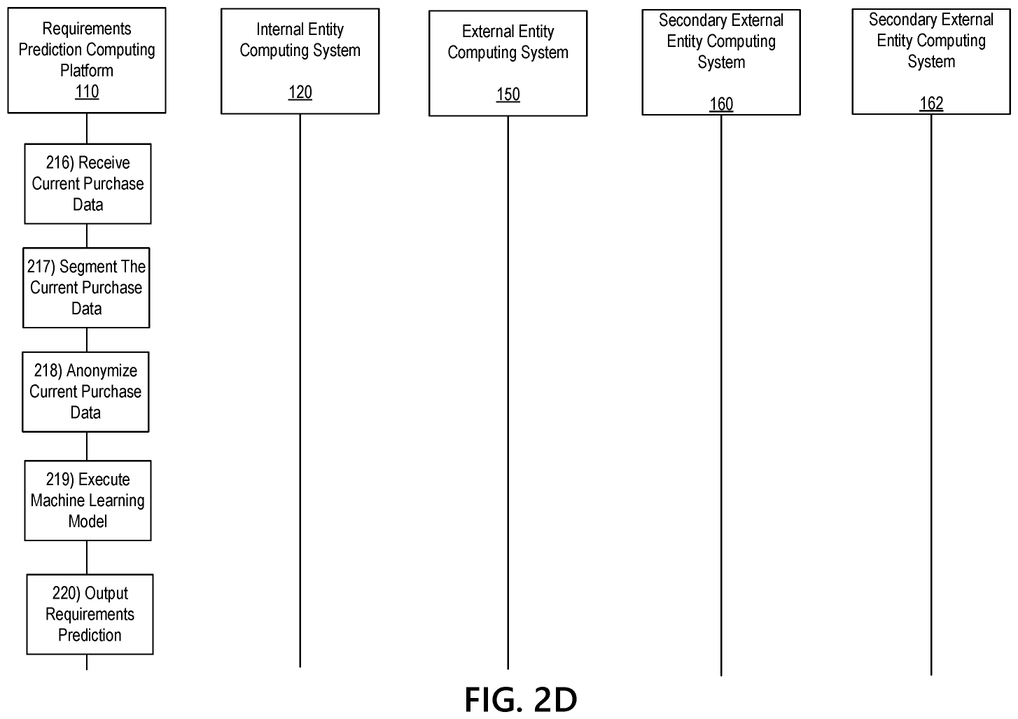

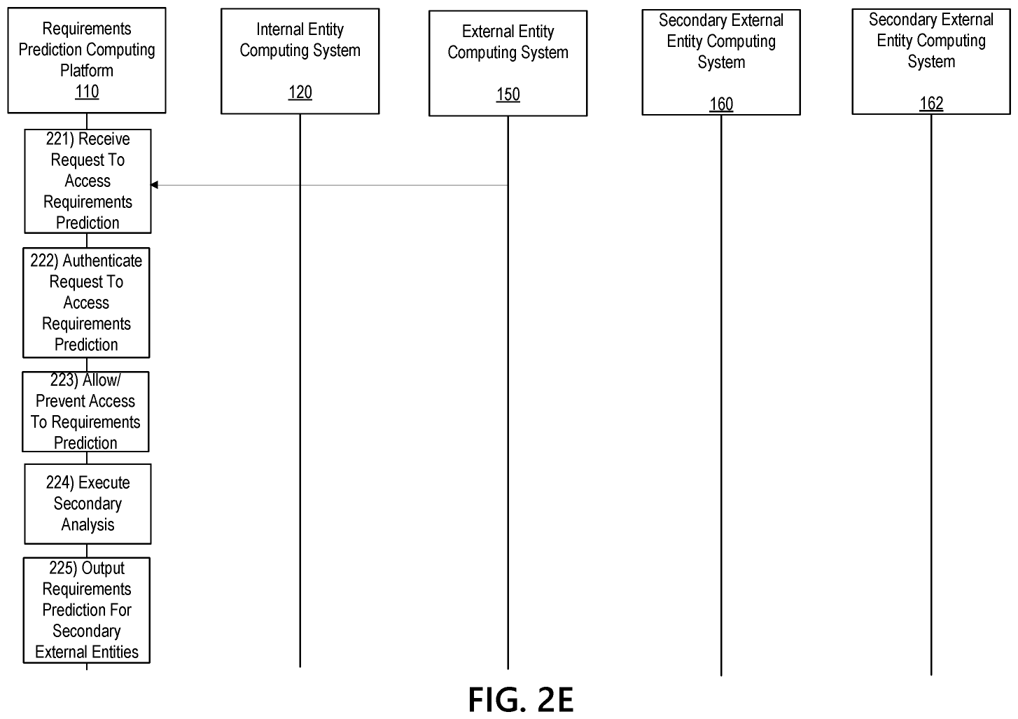

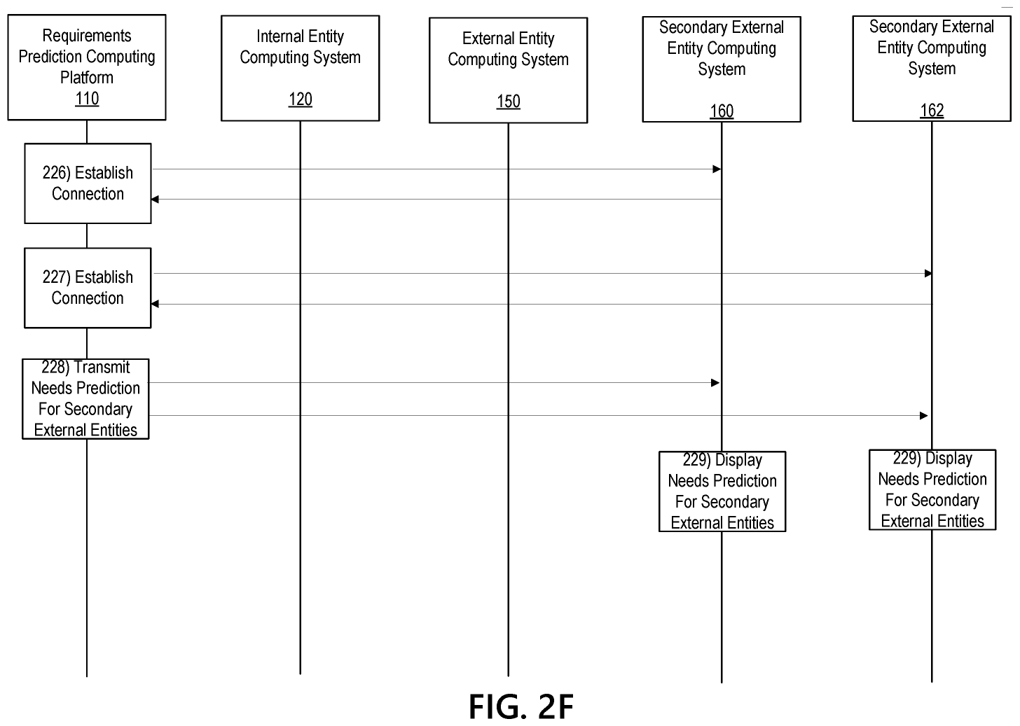

FIGS. 2A-2F depict one example illustrative event sequence for implementing requirements predictions functions in accordance with one or more aspects described herein. The events shown in the illustrative event sequence are merely one example sequence and additional events may be added, or events may be omitted, without departing from the invention. Further, one or more processes discussed with respect to FIGS. 2A-2F may be performed in real-time or near real-time.

With reference to FIG. 2A, at step 201, requirements prediction computing platform 110 may receive registration data. For instance, data associated with one or more customers, vendors, suppliers, service providers, or other entities, may be received. The registration data may include identification of the entity, identification of item types associated with the entity, authentication data of the entity, and the like.

At step 202, the requirements prediction computing platform 110 may store the registration data. For instance, the requirements prediction computing platform 110 may modify one or more databases to add entries for new entities registering with the requirements prediction computing platform 110.

At step 203, requirements prediction computing platform 110 may generate a request for historical data. For instance, requirements prediction computing platform 110 may generate a request for historical data associated with purchases, transactions, external events, timing of transactions or purchases, and the like.

At step 204, requirements prediction computing platform 110 may establish a connection with the internal entity computing system 120. For instance, a first wireless connection may be established between the requirements prediction computing platform 110 and the internal entity computing system 120. Upon establishing the first wireless connection, a communication session may be initiated between the requirements prediction computing platform 110 and the internal entity computing system 120.

At step 205, requirements prediction computing platform 110 may transmit or send the request for historical data to the internal entity computing system 120. For instance, the requirements prediction computing platform 110 may send the request for historical data during the communication session initiated upon establishing the first wireless connection.

With reference to FIG. 2B, at step 206, internal entity computing system 120 may receive and execute the request for historical data. For instance, in executing the request for historical data, transaction data, purchase data, external event data, time and date data of transactions or purchases, and the like may be identified.

At step 207, internal entity computing system 120 may generate response data responsive to the request for historical data. For instance, the identified transaction and associated data may be used to generate response data.

At step 208, internal entity computing system 120 may transmit or send the response data to the requirements prediction computing platform 110.

At step 209, requirements prediction computing platform 110 may establish a connection with the external entity computing system 150. For instance, a second wireless connection may be established between the requirements prediction computing platform 110 and the external entity computing system 150. Upon establishing the second wireless connection, a communication session may be initiated between the requirements prediction computing platform 110 and the external entity computing system 150.

At step 210, requirements prediction computing platform 110 may transmit or send the request for historical data to the external entity computing system 150. For instance, the requirements prediction computing platform 110 may send the request for historical data during the communication session initiated upon establishing the second wireless connection.

With reference to FIG. 2C. at step 211, external entity computing system 150 may receive and execute the request for historical data. For instance, in executing the request for historical data, transaction data, purchase data, external event data, time and date data of transactions or purchases, and the like may be identified.

At step 212, external entity computing system 150 may generate response data responsive to the request for historical data. For instance, the identified transaction and associated data may be used to generate response data.

At step 213, external entity computing system 150 may transmit or send the response data to the requirements prediction computing platform 110.

At step 214, requirements prediction computing platform 110 may receive the historical response data generated by each of the internal entity computing system 130 and external entity computing system 150. Although the figures show data requested from one external entity computing system 150, requests for data may be sent to additional external entity computing systems without departing from the invention.

At step 215, requirements prediction computing platform 110 may train a machine learning model. For instance, the historical response data generated by each of the internal entity computing system 130 and external entity computing system 150 may be used to train a machine learning model to identify patterns or sequences in data and output one or more recommendations or requirements predictions. For instance, this historical response data may include data related to purchases made, items purchase, time of day, day of week, time of year, external factors (e.g., natural disasters, or the like) and that data may be used to train the machine learning model to identify correlations between transaction or purchase data and requirements predictions. Accordingly, the machine learning model may use, as inputs, current data associated with one or more purchases, or the like, and the inputs may be analyzed using the machine learning model to identify patterns or sequences in the data that may correlated to one or more requirements predictions. In some examples, the machine learning model may be further trained to identify, based on items purchased, identified requirements predictions, or the like, suppliers of materials associated with manufacture of particular items and may identify volumes, inventory, or the like, to recommend to the suppliers of the materials.

With reference to FIG. 2D, at step 216, current purchase data may be received. For instance, current purchase data may be received from an internal system, an external system, from a user device (e.g., via upload of a receipt), from transaction data, or the like. The current purchase item data may include items purchased, amounts paid, time, date, or the like.

At step 217, the current purchase data may be segmented to identify particular item(s) purchase and associate an item type to each item. In some examples, data associated with each item type may be analyzed individually rather than together with data from other item types. In some examples, the segmented data may be aggregated with other segmented data associated with an item type.

At step 218, the segmented data may be anonymized to remove personal, private, confidential, or the like, information associated with a user. For instance, data stripping or data masking may be used to obscure or remove personal data (e.g., names, addresses, credit card numbers, or the like).

At step 219, the machine learning model may be executed. For instance, the segmented, anonymized data (and, in some examples, data aggregated by item type) may be input to the machine learning model. The model may be executed to output one or more requirements or needs predictions.

Accordingly, at step 220, the needs or requirements prediction may be output by the requirements prediction computing platform 110. In some examples, the requirements prediction may include a number of volume of items that will be needed to satisfy consumer needs over a period of time. Additionally or alternatively, requirements predictions may include a current cash position of an entity based on analysis of current spending data (e.g., receipt uploads) using machine learning models trained based on historical data.

With reference to FIG. 2E, at step 221, requirements prediction computing platform 110 may receive a request to access the requirements prediction output by the machine learning model. In some examples, the request to access the requirements prediction may be received from an external entity computing system, such as external entity computing system 150.

At step 222, the requirements prediction computing platform 110 may authenticate the request to access the requirements prediction data. For instance, the requirements prediction computing platform 110 may validate that the entity requesting access to the requirements prediction data (e.g., the entity associated with external entity computing system 150) is registered and authorized to access the data. In some examples, a public/private key pair may be used to validate the entity. In other examples, validation credentials may be provided with the request to access the data and may be compared to validation credentials stored during a registration process.

If validated, the requirements prediction computing platform 110 may identify the data that may be accessible to the entity. For instance, in some examples, entities may have limited access to requirements predictions associated with certain item types. Accordingly, entities might not be permitted to access all requirements predictions data.

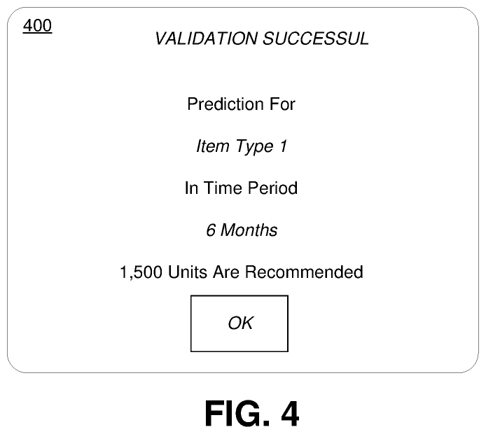

At step 223, requirements prediction computing platform 110 may, based on output of validation of the entity, permit or deny access to the data. If access to the data is permitted, the external entity computing system 150 may access permitted data types (e.g., requirements predictions associated with item types also associated with the external entity computing system 150). For instance, FIG. 4 illustrates one example user interface 400 that includes the requirements prediction for a first item type and time period. The user interface 400 may be accessed by the external entity computing system 150 upon validation of the request.

At step 224, requirements prediction computing platform 110 may execute a secondary analysis. For instance, the requirements prediction data may be further analyzed to identify suppliers (e.g., secondary external entities) associated with raw materials needed to manufacture items in the requirements prediction, identify amounts or volumes of one or more raw materials to manufacture the identified number of items in the requirements prediction, and the like. In some examples, the machine learning model may be used to generate these outputs.

At step 225, the secondary analysis may output one or more requirements predictions for secondary external entities.

With reference to FIG. 2F, at step 226, requirements prediction computing platform 110 may establish a connection with the secondary external entity computing system 160. For instance, a third wireless connection may be established between the requirements prediction computing platform 110 and the secondary external entity computing system 160. Upon establishing the third wireless connection, a communication session may be initiated between the requirements prediction computing platform 110 and the secondary external entity computing system 160.

At step 227, requirements prediction computing platform 110 may establish a connection with the secondary external entity computing system 162. For instance, a fourth wireless connection may be established between the requirements prediction computing platform 110 and the secondary external entity computing system 162. Upon establishing the fourth wireless connection, a communication session may be initiated between the requirements prediction computing platform 110 and the secondary external entity computing system 162.

At step 228, requirements prediction computing platform 110 may transmit the second requirements predictions to one or more secondary entities, such as secondary external entity computing system 160, secondary external entity computing system 162, or the like. In some examples, sending the secondary requirements predictions may cause the secondary requirements predictions to be displayed by a display of a respective computing system.

At step 229, secondary external entity computing system 160 and secondary external entity computing system 162 may display the secondary requirements predictions.

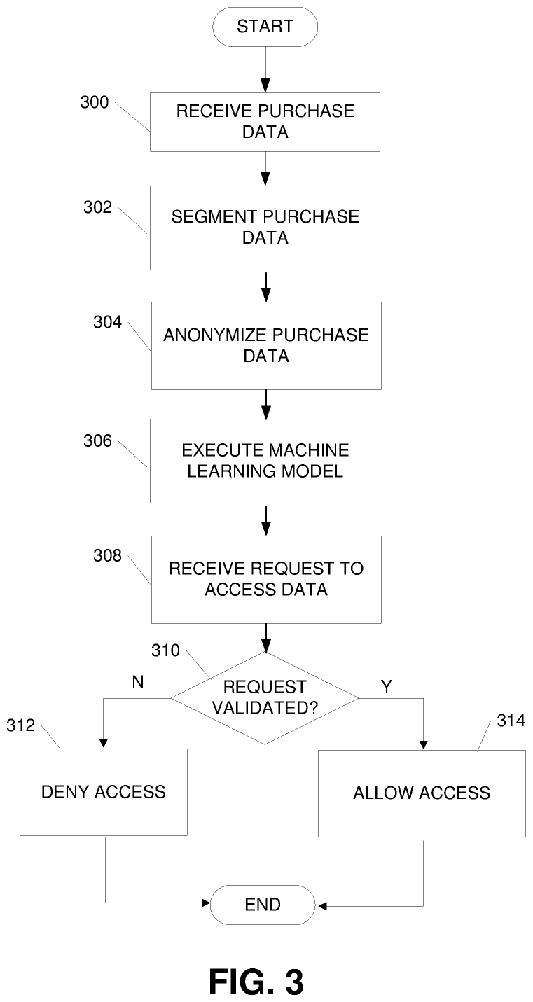

FIG. 3 is a flow chart illustrating one example method of implementing machine-learning based requirement prediction in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive purchase data. For instance, the computing platform may receive purchase data from a plurality of entities via upload of one or more receipts, from transaction data, or the like.

At step 302, the computing platform may segment the received purchase data. For instance, if multiple items were purchased, the data may be segmented according to item type. In some examples, data of a same item type may be aggregated for analysis.

At step 304, the computing platform may anonymize the segmented data. For instance, data masking or data stripping may be used to remove sensitive, confidential or personal information associated with users related to the purchase data.

At step 306, the computing platform may execute a machine learning model. In some examples, the machine learning model may be trained using historical purchase data. In some arrangements, executing the machine learning model may include inputting the segmented, anonymized purchase data into the model to output a requirements prediction for each item type. In some examples, the requirements prediction for each item type may include a predicted number or volume of the first item type to manufacture for a predetermined period of time (e.g., 1000 units should be manufactured to satisfy customers needs for the next six months).

At step 308, the computing platform may receive a request to access the requirements prediction data for a first item type. The request may be received from a first external entity system.

At step 310, a determination may be made as to whether the request to access the requirements prediction data for the first item type is validated. If not, the request to access data may be denied. If so, the request to access data may be granted. In some examples, determining whether the request to access data is validated may be based on a public/private key pair.

In some examples, further analysis may be performed on the segmented, anonymized purchase data. For instance, the data may be further analyzed to identify one or more secondary external entities associated with the first external entity system, as well as additional material requirements associated with the identified secondary external entities. For instance, the additional material requirements may include an amount of raw materials to manufacture a number of the first item type in the requirements prediction for the first item type. In some examples, the secondary external entities may be suppliers of an entity associated with the first external entity system.

The additional material requirements may, in some examples, be transmitted or sent to the identified secondary external entities. In some examples, transmitting the additional material requirements may cause the additional material requirements to be displayed by a display of a computing device associated with each identified secondary external entity.

Accordingly, aspects described herein rely on machine-learning to process particular data in order to predict needs associated with particular entities and secondary entities. For instance, based on analyzed purchase data, and, in some examples, additional data such as date, time, external factors, time of year, or the like, requirements predictions for manufacturing entities may be generated to indicate a volume or number of items to manufacture to satisfy customer needs for a particular period of time. In some examples, the arrangements described may also generate recommendations for suppliers of raw materials to the manufacturer. For instance, if a particular number or volume of units of a first item type is identified in a requirements prediction, an amount of raw materials to manufacture that volume or number of units may be identified as well and communicated to secondary suppliers.

Accordingly, the arrangements described herein provide a multi-layered analysis of the data. For instance, the analysis in some ways may be compared to tentacles that may analyze and generate not only primary data and primary uses of the data, but also secondary, tertiary, and the like. In some examples, segmented data (e.g., decompiled data) may be aggregated with or recompiled with other data to product modified data that may be used in different ways (e.g., to identify raw materials for secondary entities, identify transportation or logistics recommendations, or the like).

Accordingly, aspects described herein provide for reliable manufacture and supply of goods and/or services to customers. In some examples, the analysis may be used to identify particular services that may be of need to consumers and may, in some examples, be industry-specific. Further, in some examples, predictions may be made for period of time and/or a particular location. For instance, a city, state, region, zip code, or the like, may be identified as having a particular need for a particular volume or number of goods or services of an item type over a time period. This may enable more efficient supply of materials to manufacturers, manufacture of goods, and the like. For instance, if a predicted need is increasing, the manufacturer can ramp up in advance of the actual need to ensure availability and reliability to customers. Further, by generating recommendations based on, at least in part, consumer purchase data, accuracy of predictions may be increased.

Although various arrangements described herein are directed to identifying requirements predictions for manufactured goods, in some examples, the arrangements described herein may provide insight into a cash position of an enterprise organization. For instance, enterprise organizations may have employees who spend organization money via a corporate credit card, personal credit card that is reimbursed, or the like. Until reimbursement is requested, or a bill is paid, it may be difficult for the enterprise organization to identify a real-time cash position (e.g., how much cash on hand vs. how much is owed). Accordingly, the arrangements described herein provide for users or employees to upload receipts or bills which may be analyzed by the machine learning engine to generate a cash position prediction. The cash position prediction may be based on historical data used to train the machine learning model and the machine learning model may consider a plurality of factors such as time of year, time of month, typical fees paid, number of users, and the like.

Further, the machine learning arrangements described herein may provide cash position predictions or projections for not only a current month or upcoming month but also for longer time periods (e.g., six months, one year, or the like). These predictions may be leveraged by the enterprise organization to provide a more accurate depiction of risk associated with the organization. Accordingly, terms for loans or other banking products may be improved based on the more accurate understanding of the cash position. Further, financial institutions may leverage predictions to identify and offer additional products, services, or the like.

In some examples, the receipt upload data may be used to not only generate entity wide predictions, but may also be used to predict processing of the receipt. For instance, if a purchase is made that falls within a particular type of reimbursement account (e.g., flexible spending account (FSA)), that receipt may be processed and, regardless of type of payment device, may be automatically routed for payment from the FSA.

Further, while aspects described herein are directed to generated requirements recommendations, in some examples, the recommendations may be further analyzed to determine whether the identified requirements or needs are one-time needs or may be sustained or recurring needs. In some examples, this analysis may be performed using additional factors such as time of year, overall economic outlook of an area, number of receipts associated with a particular item type (e.g., if typical is less than ten receipts and have seen over 100 receipts for recent months may indicate sustained growth), or the like.

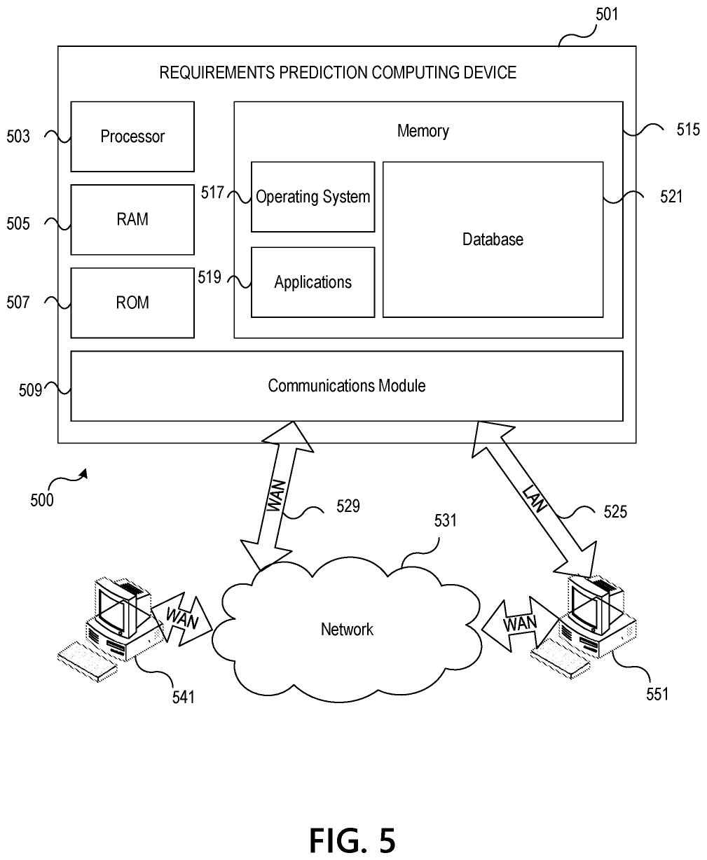

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include requirements prediction computing device 501 having processor 503 for controlling overall operation of requirements prediction computing device 501 and its associated components, including Random Access Memory (RAM) 505, Read-Only Memory (ROM) 507, communications module 509, and memory 515. Requirements prediction computing device 501 may include a variety of computer readable media. Computer readable media may be any available media that may be accessed by requirements prediction computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by requirements prediction computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on requirements prediction computing device 501. Such a processor may execute computer-executable instructions stored on a computer-readable medium.

Software may be stored within memory 515 and/or storage to provide instructions to processor 503 for enabling requirements prediction computing device 501 to perform various functions as discussed herein. For example, memory 515 may store software used by requirements prediction computing device 501, such as operating system 517, application programs 519, and associated database 521. Also, some or all of the computer executable instructions for requirements prediction computing device 501 may be embodied in hardware or firmware. Although not shown, RAM 505 may include one or more applications representing the application data stored in RAM 505 while requirements prediction computing device 501 is on and corresponding software applications (e.g., software tasks) are running on requirements prediction computing device 501.

Communications module 509 may include a microphone, keypad, touch screen, and/or stylus through which a user of requirements prediction computing device 501 may provide input, and may also include one or more of a speaker for providing audio output and a video display device for providing textual, audiovisual and/or graphical output. Computing system environment 500 may also include optical scanners (not shown).

Requirements prediction computing device 501 may operate in a networked environment supporting connections to one or more other computing devices, such as computing device 541 and 551. Computing devices 541 and 551 may be personal computing devices or servers that include any or all of the elements described above relative to requirements prediction computing device 501.

The network connections depicted in FIG. 5 may include Local Area Network (LAN) 525 and Wide Area Network (WAN) 529, as well as other networks. When used in a LAN networking environment, requirements prediction computing device 501 may be connected to LAN 525 through a network interface or adapter in communications module 509. When used in a WAN networking environment, requirements prediction computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, from a plurality of entities, purchase data for a plurality of items;
segment the purchase data based on item type;
anonymize the purchase data;
execute a machine learning model, wherein executing the machine learning model includes inputting the segmented, anonymized purchase data to the machine learning model to output a requirements prediction for each item type;
receive, from a first external entity system, a request to access the requirements prediction for a first item type;
validate the request to access the requirements prediction for the first item type by the first external entity system; and
responsive to validating the request to access the requirements prediction for the first item type by the first external entity system, allow the first external entity system to access the requirements prediction for the first item type.

2. The computing platform of claim 1, wherein the requirements prediction for the first item type includes a predicted number of the first item type to manufacture for a period of time.

3. The computing platform of claim 1, further including instructions that, when executed, cause the computing platform to:
further analyze the purchase data and requirements prediction for the first item type to identify secondary external entities associated with the first external entity system and additional material requirements associated with the identified secondary external entities; and
transmit the additional material requirements to the identified secondary external entities, wherein transmitting the additional material requirement to the identified secondary external entities causes display of the additional material requirements by a display of a computing device associated with each identified secondary external entity.

4. The computing platform of claim 3, wherein the additional material requirements include an amount of raw materials to manufacture a number of the first item type in the requirements prediction for the first item type.

5. The computing platform of claim 3, wherein the secondary external entities are suppliers of an entity associated with the first external entity system.

6. The computing platform of claim 1, wherein validating the request to access the requirements prediction for the first item type by the first external entity system is based on a public/private key pair.

7. The computing platform of claim 1, further including instructions that, when executed, cause the computing platform to:
train the machine learning model using historical purchase data received from a plurality of entities.

8. A method, comprising:
receiving, by a computing platform, the computing platform having at least one processor and memory, and from a plurality of entities, purchase data for a plurality of items;
segmenting, by the at least one processor, the purchase data based on item type;
anonymizing, by the at least one processor, the purchase data;
executing, by the at least one processor, a machine learning model, wherein executing the machine learning model includes inputting the segmented, anonymized purchase data to the machine learning model to output a requirements prediction for each item type;
receiving, by the at least one processor and from a first external entity system, a request to access the requirements prediction for a first item type;
validating, by the at least one processor, the request to access the requirements prediction for the first item type by the first external entity system; and
responsive to validating the request to access the requirements prediction for the first item type by the first external entity system, allowing, by the at least one processor, the first external entity system to access the requirements prediction for the first item type.

9. The method of claim 8, wherein the requirements prediction for the first item type includes a predicted number of the first item type to manufacture for a period of time.

10. The method of claim 8, further including:
further analyzing, by the at least one processor, the purchase data and requirements prediction for the first item type to identify secondary external entities associated with the first external entity system and additional material requirements associated with the identified secondary external entities; and
transmitting, by the at least one processor, the additional material requirements to the identified secondary external entities, wherein transmitting the additional material requirement to the identified secondary external entities causes display of the additional material requirements by a display of a computing device associated with each identified secondary external entity.

11. The method of claim 10, wherein the additional material requirements include an amount of raw materials to manufacture a number of the first item type in the requirements prediction for the first item type.

12. The method of claim 10, wherein the secondary external entities are suppliers of an entity associated with the first external entity system.

13. The method of claim 8, wherein validating the request to access the requirements prediction for the first item type by the first external entity system is based on a public/private key pair.

14. The method of claim 8, further including:
training, by the at least one processor, the machine learning model using historical purchase data received from a plurality of entities.

15. One or more non-transitory computer-readable media storing instructions that, when executed by a computing platform comprising at least one processor, memory, and a communication interface, cause the computing platform to:
receive, from a plurality of entities, purchase data for a plurality of items;
segment the purchase data based on item type;
anonymize the purchase data;
execute a machine learning model, wherein executing the machine learning model includes inputting the segmented, anonymized purchase data to the machine learning model to output a requirements prediction for each item type;
receive, from a first external entity system, a request to access the requirements prediction for a first item type;
validate the request to access the requirements prediction for the first item type by the first external entity system; and
responsive to validating the request to access the requirements prediction for the first item type by the first external entity system, allow the first external entity system to access the requirements prediction for the first item type.

16. The one or more non-transitory computer-readable media of claim 15, wherein the requirements prediction for the first item type includes a predicted number of the first item type to manufacture for a period of time.

17. The one or more non-transitory computer-readable media of claim 15, further including instructions that, when executed, cause the computing platform to:
further analyze the purchase data and requirements prediction for the first item type to identify secondary external entities associated with the first external entity system and additional material requirements associated with the identified secondary external entities; and
transmit the additional material requirements to the identified secondary external entities, wherein transmitting the additional material requirement to the identified secondary external entities causes display of the additional material requirements by a display of a computing device associated with each identified secondary external entity.

18. The one or more non-transitory computer-readable media of claim 17, wherein the additional material requirements include an amount of raw materials to manufacture a number of the first item type in the requirements prediction for the first item type.

19. The one or more non-transitory computer-readable media of claim 17, wherein the secondary external entities are suppliers of an entity associated with the first external entity system.

20. The one or more non-transitory computer-readable media of claim 15, wherein validating the request to access the requirements prediction for the first item type by the first external entity system is based on a public/private key pair.

21. The one or more non-transitory computer-readable media of claim 15, further including instructions that, when executed, cause the computing platform to:
train the machine learning model using historical purchase data received from a plurality of entities.
